(19) United States
(12) Patent Application Publication
(10) Pub. No.: US 2025/0080369 A1
(43) Pub. Date: Mar. 6, 2025

(54) SYSTEMS AND METHODS FOR REAL-TIME AUTOMATIC REBILLING OF METERED ACTIVITIES IN A TIERED SOFTWARE FRAMEWORK

(71) Applicant: HighLevel Inc., Dallas, TX (US)

(72) Inventors: Shivam Tiwari, Toronto (CA); Ashutosh Anand, Bokaro (IN); Rishabh Rajput, Mainpuri (IN); Shubham Gupta, Lucknow (IN); Shaun Clark, Eugene, OR (US); Robin Alex, Dallas, TX (US); Varun Vairavan, Doha (QA)

(73) Assignee: HighLevel Inc., Dallas, TX (US)

(21) Appl. No.: 18/457,510

(22) Filed: Aug. 29, 2023

(51) Int. Cl. H04L 12/14

(52) U.S. Cl. CPC H04L 12/146; H04L 12/1432

(57) ABSTRACT

Embodiments of a method for automatically rebilling a metered activity comprise: detecting a metered activity in a tiered software framework having a first tier, a second tier, and a third tier with a first subscriber subscribed to the second tier, and a second subscriber subscribed to the third tier; instantiating a meter to monitor usage of the metered activity; simultaneously instantiating a first debit service at the first tier and a second debit service at the second tier; computing, by the first debit service, first usage credits of the usage; debiting the first usage credits from a first digital wallet of the first subscriber at the second tier; computing, by the second debit service, second usage credits of the usage; and debiting the second usage credits from a second digital wallet of the second subscriber at the third tier.

### TECHNICAL FIELD

The present disclosure relates to systems, techniques, and methods directed to real-time automatic rebilling of metered activities in a tiered software framework.

### BACKGROUND

Cloud computing services include storage, network, and computing, facilitating various service models, such as infrastructure as a service (IaaS), platform as a service (PaaS) and software as a service (Saas). The increasing numbers of applications, data and services offered in the cloud pose a challenge to service providers and enterprises in managing demand and metering usage. In particular, certain SaaS providers may monitor certain usage of their software, subjecting the usage to metering charges according to various payment models.

### BRIEF DESCRIPTION OF THE DRAWINGS

Embodiments will be readily understood by the following detailed description in conjunction with the accompanying drawings. To facilitate this description, like reference numerals designate like elements. Embodiments are illustrated by way of example, and not by way of limitation, in the figures of the accompanying drawings.

FIG. 1 is a simplified block diagram illustrating a rebilling application for real-time automatic rebilling of metered activities in a tiered software framework, according to some embodiments of the present disclosure.

FIG. 2 is a simplified block diagram illustrating example details of the tiered software framework implementing the real-time automatic rebilling of metered activities, according to some embodiments of the present disclosure.

FIG. 3 is a simplified block diagram illustrating other example details of the tiered software framework implementing the real-time automatic rebilling of metered activities, according to some embodiments of the present disclosure.

FIG. 4 is a simplified block diagram illustrating example details of the rebilling application for real-time automatic rebilling of metered activities, according to some embodiments of the present disclosure.

FIG. 5 is a simplified block diagram illustrating other example details of the rebilling application for real-time automatic rebilling of metered activities, according to some embodiments of the present disclosure.

FIG. 6 is a simplified block diagram illustrating other example details of the rebilling application for real-time automatic rebilling of metered activities, according to some embodiments of the present disclosure.

FIGS. 7A-7E are simplified diagrams illustrating example user interfaces of the rebilling application for real-time automatic rebilling of metered activities, according to some embodiments of the present disclosure.

FIG. 8 is a simplified flow diagram illustrating example operations associated with the rebilling application for real-time automatic rebilling of metered activities, according to some embodiments of the present disclosure.

FIG. 9 is a simplified flow diagram illustrating yet other example operations associated with the rebilling application for real-time automatic rebilling of metered activities, according to some embodiments of the present disclosure.

FIG. 10 is a simplified flow diagram illustrating yet other example operations associated with the rebilling application for real-time automatic rebilling of metered activities, according to some embodiments of the present disclosure.

### DETAILED DESCRIPTION

### Overview

For purposes of illustrating the embodiments described herein, it is important to understand certain terminology and operations of technology networks. The following foundational information may be viewed as a basis from which the present disclosure may be properly explained. Such information is offered for purposes of explanation only and, accordingly, should not be construed in any way to limit the broad scope of the present disclosure and its potential applications.

Measuring resource usage for billing purposes is commonly implemented in cloud-based service delivery platforms. Currently available metering and billing systems generally meter resource usage and/or provide subscription-based models. Typical SaaS metering and billing follow a monthly fixed cost (e.g., monthly subscription), depending on the amount of data or the number of subscribers. Subscription based billing allows for business to sell periodic (monthly, yearly, etc.) access to cloud-based products and services. Alternately, activity-based billing creates a process for measuring, aggregating, analyzing, rating, charging, invoicing, payment processing, and reporting on individual subscriber or user engagements. Activities that can be rated, metered, and charged may be identified and tracked in such models. Examples of such activities include downloading a file, streaming data (e.g., music, video), communicating, uploading photos, viewing a file, playing a game, etc. The cloud service provider determines meterable activities and bills accordingly.

Typically, activity-based billing is passed through from the cloud service provider to the SaaS provider and onto their subscribers. Such a scheme works satisfactorily where there are only two tiers in an application, for example, the SaaS provider and its subscribers. However, where the number of tiers is larger, for example, where the subscriber has its own subscribers at a different tier with different access credentials and billing rates, the scheme does not scale appropriately. Thus, when a metered activity is managed separately by the various tiers, there could be confusion about what is being metered and at what rates, particularly in frameworks where the tiers operate opaquely with respect to each other (i.e., there is no data sharing between non-adjacent tiers). For example, considerable resources may need to be spent to tally up costs charged by the upstream SaaS provider and the prices paid by downstream subscribers. Further, currently available activity-based billing may fail to take certain application specific activities into account, or they may overcharge for activities that are not significant for the specific application, among other disadvantages, leading to a loss of trust in the framework. There are currently no solutions that provide a suitable metering approach, where the application's unique features are considered in generating bills specific thereto.

Accordingly, embodiments of the system disclosed herein facilitate automatic rebilling of metered activities in a tiered software framework. In one embodiment, a method is provided, comprising detecting a metered activity in a tiered software framework with a first tier, a second tier, and a third tier, in which a first subscriber is subscribed to the second tier, a second subscriber is subscribed to the third tier, and the metering activity is by the second subscriber. A meter is instantiated to monitor usage of the metered activity. Simultaneously, a first debit service is instantiated at the first tier and a second debit service is instantiated at the second tier. The first debit service computes first usage credits of the usage and debits the first usage credits from a first digital wallet of the first subscriber at the second tier. The second debit service computes second usage credits of the usage and debits the second usage credits from a second digital wallet of the second subscriber at the third tier.

In another embodiment, the method includes providing a first tier, a second tier and a third tier in a software framework, in which data in the first tier is accessible at the first tier and inaccessible at the second tier and the third tier, data in the second tier is accessible at the first tier and the second tier and inaccessible at the third tier, and data in the third tier is accessible at the first tier, the second tier and the third tier. A first digital wallet is provided in the second tier and a second digital wallet is provided in the third tier. A first payment process is provided in the first tier and a second payment process is provided in the second tier. When it is determined at the first tier that available credits in the first digital wallet are below a predetermined threshold, a first number of credits is purchased by the first payment process using information on a first payment card provided at the second tier. When it is determined at the second tier that available credits in the second digital wallet are below another predetermined threshold, a second number of credits is purchased by the second payment process using information on a second payment card provided at the third tier. A first credit addition service at the first tier adds the first number of credits to the first digital wallet. A second credit addition service at the second tier adds the second number of credits to the second digital wallet.

In the following detailed description, various aspects of the illustrative implementations may be described using terms commonly employed by those skilled in the art to convey the substance of their work to others skilled in the art.

The term “connected” means a direct connection (which may be one or more of a communication, mechanical, and/or electrical connection) between the things that are connected, without any intermediary devices, while the term “coupled” means either a direct connection between the things that are connected, or an indirect connection through one or more passive or active intermediary devices.

The term “computing device” means a server, a desktop computer, a laptop computer, a smartphone, or any device with a microprocessor, such as a central processing unit (CPU), general processing unit (GPU), or other such electronic component capable of executing processes of a software algorithm (such as a software program, code, application, macro, etc.).

The term “cloud network” means a network of computing devices coupled together in a public, private, or hybrid communications network. Communication in the cloud network may use one or more wired, wireless, broadband, radio, and other kinds of communicative means. The Internet is an example of a cloud network.

As used herein, the term “application” can be inclusive of an executable file comprising instructions that can be understood and processed on a computing device such as a computer, and may further include library modules loaded during execution, object files, system files, hardware logic, software logic, or any other executable modules. Applications are generally configured to perform particular tasks, or functions according to the type of application.

The description uses the phrases “in an embodiment” or “in embodiments,” which may each refer to one or more of the same or different embodiments.

Although certain elements may be referred to in the singular herein, such elements may include multiple sub-elements. For example, “a computing device” may include one or more computing devices.

Unless otherwise specified, the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

In the following detailed description, reference is made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

The accompanying drawings are not necessarily drawn to scale. In the drawings, same reference numerals refer to the same or analogous elements shown so that, unless stated otherwise, explanations of an element with a given reference numeral provided in context of one of the drawings are applicable to other drawings where element with the same reference numerals may be illustrated. Further, the singular and plural forms of the labels may be used with reference numerals to denote a single one and multiple ones respectively of the same or analogous type, species, or class of element.

Note that in the figures, various components are shown as aligned, adjacent, or physically proximate merely for ease of illustration; in actuality, some or all of them may be spatially distant from each other. In addition, there may be other components, such as routers, switches, antennas, communication devices, etc. in the networks disclosed that are not shown in the figures to prevent cluttering. Systems and networks described herein may include, in addition to the elements described, other components and services, including network management and access software, connectivity services, routing services, firewall services, load balancing services, content delivery networks, virtual private networks, etc. Further, the figures are intended to show relative arrangements of the components within their systems, and, in general, such systems may include other components that are not illustrated (e.g., various electronic components related to communications functionality, electrical connectivity, etc.).

In the drawings, a particular number and arrangement of structures and components are presented for illustrative purposes and any desired number or arrangement of such structures and components may be present in various embodiments. Further, unless otherwise specified, the structures shown in the figures may take any suitable form or shape according to various design considerations, manufacturing processes, and other criteria beyond the scope of the present disclosure.

For convenience, if a collection of drawings designated with different letters are present (e.g., FIGS. 11A-11G), such a collection may be referred to herein without the letters (e.g., as “FIG. 11”). Similarly, if a collection of reference numerals designated with different letters are present (e.g., 106a, 106b), such a collection may be referred to herein without the letters (e.g., as “106”) and individual ones in the collection may be referred to herein with the letters. Further, labels in upper case in the figures (e.g., 106A) may be written using lower case in the description herein (e.g., 106a) and should be construed as referring to the same elements.

Various operations may be described as multiple discrete actions or operations in turn in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

### Example Embodiments

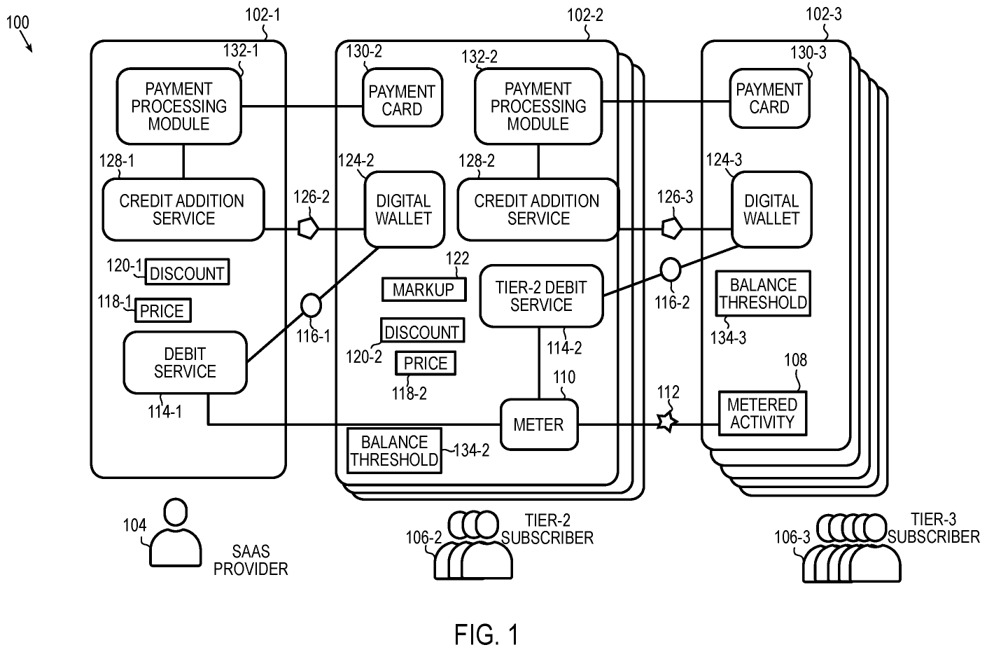

FIG. 1 is a simplified block diagram illustrating an example rebilling application 100. Rebilling application 100 may comprise various tiers 102. In the example embodiment shown, rebilling application 100 has three tiers: 102-1, 102-2, and 102-3. Note that the labeling convention followed herein uses the hyphen followed by a number to denote a separate tier corresponding to the number (e.g., “−1” denotes tier −1, “−2” denotes tier-2, and “−3” denotes tier-3). Rebilling application 100 may be managed by a SaaS provider 104, who may provide one or more downstream subscriber 106-2 at tier 102-2 with access to rebilling application 100. In turn, subscriber 106-2 may provide one or more downstream subscriber 106-3 at tier 102-3 with access to rebilling application 100. SaaS provider 104 and subscribers 106 (e.g., 106-2 and 106-2) may include an entity (i.e., a company, an organization, etc.) in various embodiments. Human users at SaaS provider 104, and subscribers 106 may operate or otherwise use rebilling application 100 through one or more devices such as computers, laptops, smartphones, mobile computing devices, mobile phones, iPads™, Google Droids™, Microsoft® Surface™, etc.

In various embodiments, a single one of SaaS provider 104 may have multiple subscribers 106-2 at tier 102-2; a single one of subscriber 106-2 at tier 102-2 may have multiple subscribers 106-3 at tier 102-3. Subscribers 106-2 may have accounts with SaaS provider 104 at tier 102-1; subscribers 106-3 may have accounts with subscribers 106-2 at tier 102-2. In various embodiments, SaaS provider 104 may bill subscribers 106-2; subscribers 106-2 in turn may bill subscribers 106-3. The billing at each tier 102 may be based on a variety of factors that may or may not be independent of each other, including application resources used by subscribers 106, number of individual users authorized by subscribers 106 to access rebilling application 100, and usage of one or more metered activity 108.

Individual users of subscriber 106-3 (or 106-2) may initiate metered activity 108 through one or more devices while accessing (and executing) various functionalities of rebilling application 100. Metered activity 108 includes any action (e.g., function call, function exit, mouse click, keyboard entry, cursor movement, joystick movement or touchpad-detected movement, application state change, etc.) associated with rebilling application 100 that affects a billing status of an account of subscriber 106 in rebilling application 100, for example, by causing a billing entry to be added to the account of subscriber 106. In an example embodiment, such actions may be associated with communication events, such as sending of an email message, or a short message service (SMS) text, or initiating a Voice over Internet Protocol (VoIP) call, using an application such as WhatsApp™ or Messenger™ for marketing activities, accessing a marketing social media account, etc. Any such activity that can be monitored for time of the activity, type of the activity, duration of the activity and access credentials of the user performing the activity (among other metering attributes) is included as a “metered activity” within the broad scope of the embodiments described herein.

Whether an action constitutes metered activity 108 may depend on the specific terms of subscriber 106's agreement with their upstream provider according to the broad scope of the embodiments herein. For example, sending an email message may be one of metered activity 108 billed by SaaS provider 104 to subscriber 106-2, whereas subscriber 106-2 may not bill email messages to their downstream subscribers 106-3 for the first month of business engagement. In some embodiments, a particular one of metered activity 108 may be billed at both tier-1 and tier-2. In some other embodiments, a particular one of metered activity 108 may be billed at tier 102-1, but not at tier 102-2 and vice versa.

In various embodiments, metering and billing of metered activity 108 may occur in real-time at any one or more tiers 102. For example, a user at subscriber 106-3 may initiate metered activity 108 by sending an email message. A meter 110 may detect metered activity 108 and begin monitoring usage 112. Any suitable metering software (e.g., algorithm, code, application, etc.) may be used for metering metered activity 108 within the broad scope of the embodiments herein. Meter 110 can include polling agents (e.g., that poll tier-3 periodically for metering activity 108) or callbacks (e.g., that are triggered when metering activity 108 is detected). Meter 110 may also include other event detecting and reporting mechanisms (e.g., asynchronous service invocations other than polling or callbacks). Meter 110 may be deployed at tier 102-2 in some embodiments (e.g., as shown), and outside of any tiers 102 in other embodiments as desired and based on particular needs. Meter 110 may include hardware and software for real-time monitoring of metering activity 108.

Meter 110 may capture various metering attributes of metered activity 108 in usage 112. As used herein, the term “metering attribute” can include an attribute (e.g., a quality, feature, trait, aspect, element, characteristic, property, etc.) of rebilling application 100 that may be metered. By way of examples and not limitations, the metering attributes in a video chat service activity may include host, participant, session duration, bytes sent, etc. Other examples of metering attributes include user ID of the subscriber; session ID of the communication session; bytes sent during the communication session; and so on. Metering attributes depend on metered activity 108, and other factors based on various needs, such as business outlook, beyond the scope of the present disclosure.

Usage 112 may depend on the type (e.g., category) of metered activity 108. For example, the bytes sent during video call may comprise usage 112; whereas for SMS texts, usage 112 may be determined by the number of texts sent; in an email, the bytes sent, as also the number of emails may be computed towards usage 112. Usage 112 may be based upon the billing plan in many embodiments. For example, in some cases, the billing plan may provide for a specific rate for a certain number of emails and SMS texts; in such cases, usage 112 may comprise the number of such emails and SMS texts. In another billing plan, the rate for a certain duration of unlimited number of calls may be specified; in such cases, usage 112 may comprise the duration of calls rather their number. Usage 112 may comprise any suitable metering attribute within the broad scope of the embodiments.

Substantially simultaneously as instantiation (or initiation) of meter 110, a debit service 114 may be instantiated at different tiers 102 and begin calculating the rate of billing for usage 112. For example, tier-1 debit service 114-1 at tier 102-1 may calculate the rate of billing at tier-1 for usage 112 according to a tier-1 price 118-1, less any tier-1 discount 120-1. Substantially simultaneously, tier-2 debit service 114-2 at tier 102-2 may calculate the rate of billing at tier-2 for usage 112 according to a tier-2 price 118-2, less any tier-2 discount 120-2 plus a markup 122. Thus, instead of subscriber 106-2 at tier 102-2 being a pass-through billing entity passing on the costs of metered activity 108 from SaaS provider 104 to subscriber 106-3, subscriber 106-2 may apply discounts 120-2 and markup 122 independent of the costs charged thereon by SaaS provider 104.

In various embodiments, each metering attribute may correspond to a separate price 118, discount 120 and/or markup 122. For example, bytes sent and received may correspond to one set of {price 118, discount 120 and/or markup 122}; duration of a video chat may correspond to another set of {price 118, discount 120 and/or markup 122}; number of SMS texts may correspond to yet another set of {price 118, discount 120 and/or markup 122}; and so on. Price 118, discount 120 and markup 122 may be determined at respective tiers 102 as desired and based on particular needs. For example, one of subscriber 106-2 may decide to pass on discount 120-1 as such to downstream subscriber 106-3. Another subscriber 106-2 may decide to not apply discount 120-1 (e.g., for additional profit) to downstream subscriber 106-3. Thus, the same metered activity 108 may be assigned a tier-1 billing rate that is different from a tier-2 billing rate. In various embodiments, the differences may be opaque to downstream subscribers 106 (i.e., subscriber 106-3 may not know the price paid for metered activity 108 by subscriber 106-2); in other embodiments, the differences may be transparent to downstream subscribers 106 (i.e., subscriber 106-3 may know the price paid for metered activity 108 by subscriber 106-2).

Debit service 114 may compute usage credits 116 of usage 112 as rate of billing at respective tier 102 times usage 112 and deduct computed usage credits 116 from a digital wallet 124 of its immediately downstream subscriber 106. For example, tier-1 debit service 114-1 may deduct computed usage credits 116-1 calculated at tier 102-1 as rate of billing at tier 102-1 times usage 112 and deduct it from tier-2 digital wallet 124-2. Substantially simultaneously, tier-2 debit service 114-2 may deduct computed usage credits 116-2 calculated at tier 102-2 as rate of billing at tier 102-2 times usage 112 and deduct it from tier-3 digital wallet 124-3.

In various embodiments, digital wallet 124 may carry credits 126 paid thereinto by a credit addition service 128 at immediately upstream tier 102. For example, tier-2 digital wallet 124-2 may carry credits 126-2 paid thereinto by tier-1 credit addition service 128-1; tier-3 digital wallet 124-3 may carry credits 126-3 paid thereinto by tier-2 credit addition service 128-2.

Credits 126 may be purchased by subscriber 106 using a payment card 130 processed by a payment processing module 132 at immediately upstream tier 102. For example, subscriber 106-2 may purchase credits 126-2 using payment card 130-2 processed by payment processing module 132-1 at tier 102-1. Subscriber 106-3 may purchase credits 126-3 using payment card 130-3 processed by payment processing module 132-2 at tier 102-2. Payment card 130 may be a credit card, a debit card, a gift card, or any other type of card suitable for processing by a third-party payment processor (e.g., Stripe™, PayPal™, Venmo™, etc.) with whom payment processing module 132 is associated. For example, SaaS provider 104 may have an account with third-party payment processor Stripe™; the account may be accessed by payment processing module 132-1. Subscriber 106-2 may have an account 132-2 with third-party payment processor PayPal™; the account may be accessed by payment processing module 132-2.

In various embodiments, as debit service 114 subtracts usage credits 116 from digital wallet 124 in real-time based on usage 112 of metered activity 108, the account balance in digital wallet 124 decreases accordingly. In some embodiments, debit service 114 may monitor the account balance before debiting usage credits 116 therefrom. In some other embodiments, debit service 114 may monitor the account balance substantially simultaneously with the debiting process. If the account balance is below a predetermined balance threshold 134, payment processing module 132 may be activated; payment processing module 132 may process payment card 130, and digital wallet 124 may be replenished with credits 126. For example, debit service 114-2 may debit usage credits 116-1 from digital wallet 124-2, reducing the account balance therein. When the account balance in digital wallet 124-2 falls below balance threshold 134-2, payment processing module 132-1 may process payment card 130-2, and digital wallet 124-2 replenished with credits 126-2. When the account balance in digital wallet 124-3 falls below balance threshold 134-3, payment processing module 132-2 may process payment card 130-3, and digital wallet 124-3 replenished with credits 126-3. In various embodiments, balance threshold 134 may be set at the respective tier 102 before metered activity 108 begins, for example, during initial configuration of rebilling application 100.

The number of credits 126 to be purchased at each transaction with payment card 130 may be set manually at respective tiers 102. Merely as an example and not as a limitation, subscriber 106-2 may set a maximum credit limit of $1000 per transaction when the account balance in digital wallet 124-2 falls below balance threshold 134-2 set at $100. When the account balance in digital wallet 124-2 falls below balance threshold 134-2 of $100, payment processing module 132-1 may initiate a transaction, pulling information from payment card 130-2 to purchase credits 126-2 worth $1000 and credit addition service 128-1 may add purchased credits 126-2 into digital wallet 124-2. Adding the maximum allowed credits into digital wallet 124 thus may be called “top [ping] up” digital wallet 124. Likewise, subscriber 106-3 may set a maximum credit limit of $500 per transaction when the account balance in digital wallet 124-3 falls below balance threshold 134-3 of $10. When the account balance in digital wallet 124-3 falls below balance threshold 134-3 of $10, payment processing module 132-2 may initiate a transaction, pulling information from payment card 130-3 to purchase credits 126-3 worth $500 and credit addition service 128-2 may top up digital wallet 124-3. Note that any amount may be specified in maximum credit limit as also the balance threshold 134.

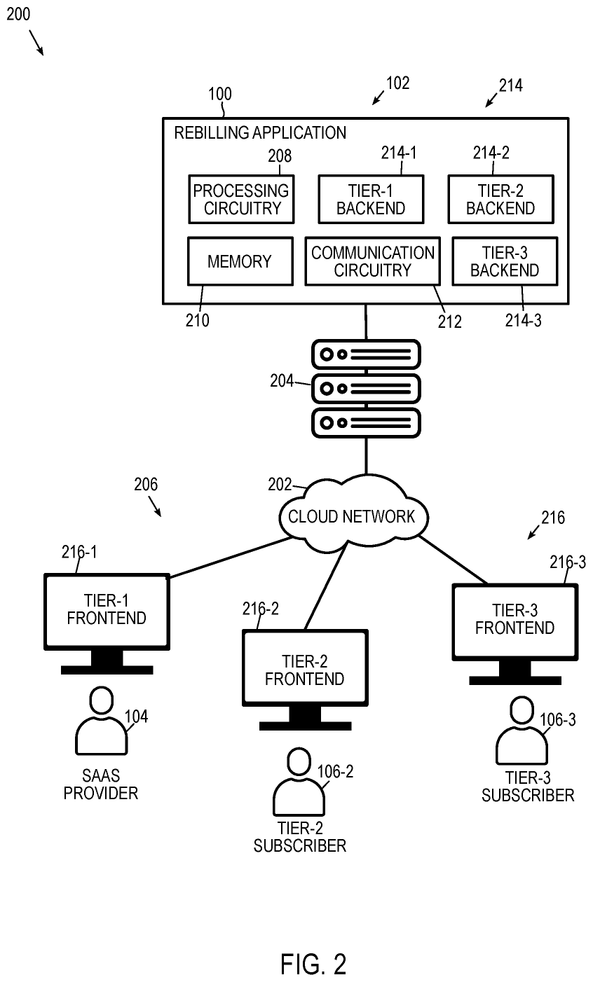

FIG. 2 is a simplified block diagram illustrating a tiered software framework 200 according to various embodiments. In example implementations, at least some portions of the activities outlined herein may be hosted on a cloud network 202 in one or more servers 204. At least some other portions of the activities outlined herein may be implemented in one or more computing devices 206 connected over one or more communication networks with cloud network 202. In particular embodiments, cloud network 202 is a collection of hardware devices and executable software forming a shared pool of configurable computing resources (e.g., networks, servers, storage, applications, services, etc.) that may be suitably provisioned to provide on-demand self-service, network access, resource pooling, elasticity and measured service, among other features. Computing device 206 may have any desired form factor, such as a handheld or mobile computing device (e.g., a cell phone, a smart phone, a mobile Internet device, a tablet computer, a laptop computer, a netbook computer, an ultra-book computer, a Personal Digital Assistant (PDA), an ultramobile personal computer, etc.), a desktop computing device, a server or other networked computing component, a set-top box, an entertainment control unit, or a wearable computing device.

Certain portions of tiered software framework 200 (e.g., rebilling application 100) may execute using a processing circuitry 208, a memory 210 and communication circuitry 212 (among other components) in one or more servers 204. Certain other portions of tiered software framework 200 may execute in one or more computing devices 206 using respective processing circuitry, memory, and communication circuitry (not shown with particularity so as not to clutter the drawing) substantially similar in functionalities to processing circuitry 208, memory 210 and communication circuitry 212. In some embodiments, one or more of these features may be implemented in hardware, provided external to these elements, or consolidated in any appropriate manner to achieve the intended functionality. The various network elements in tiered software framework 200 may include communication software that can coordinate to achieve the operations as outlined herein. In still other embodiments, these elements may include any suitable algorithms, hardware, software, components, modules, interfaces, or objects that facilitate the operations thereof.

Processing circuitry 208 may execute any type of instructions associated with data stored in memory 210 to achieve the operations detailed herein. In one example, processing circuitry 208 may transform data from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., field programmable gate array (FPGA), an erasable programmable read only memory (EPROM), an application specific integrated circuit (ASIC)) that includes digital logic, software, code, electronic instructions, flash memory, optical disks, magnetic or optical cards, other types of machine-readable mediums suitable for storing electronic instructions, or any suitable combination thereof.

In some of example embodiments, one or more memory 210 may store data used for the operations described herein. This includes memory 210 storing instructions (e.g., software, logic, code, etc.) in non-transitory media (e.g., random access memory (RAM), read only memory (ROM), FPGA, EPROM, etc.) such that the instructions are executed to carry out the activities described in this disclosure based on particular needs. In some embodiments, memory 210 may comprise non-transitory computer-readable media, including one or more memory devices such as volatile memory such as dynamic RAM (DRAM), nonvolatile memory (e.g., ROM), flash memory, solid-state memory, and/or a hard drive. In some embodiments, memory 210 may share a die with processing circuitry 208. Memory 210 may include algorithms, code, software modules, and applications, which may be executed by processing circuitry 208. The data being tracked, sent, received, or stored in tiered software framework 200 may be provided in any database, register, table, cache, queue, control list, or storage structure, based on particular needs and implementations, all of which could be referenced in any suitable timeframe.

Communication circuitry 212 may be configured for managing wired or wireless communications for the transfer of data in tiered software framework 200. The term “wireless” and its derivatives may be used to describe circuits, devices, systems, methods, techniques, communications channels, etc., that may communicate data through modulated electromagnetic radiation in a nonsolid medium. The term does not imply that the associated devices do not contain any wires, although in some embodiments they might not. Communication circuitry 212 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long Term Evolution (LTE) project along with any amendments, updates, and/or revisions (e.g., advanced LTE project, ultramobile broadband (UMB) project (also referred to as “3GPP2”), etc.). Communication circuitry 212 may operate in accordance with a Global System for Mobile Communication (GSM), General Packet Radio Service (GPRS), Universal Mobile Telecommunications System (UMTS), High-Speed Packet Access (HSPA), Evolved HSPA (E-HSPA), or LTE network. Communication circuitry 212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). Communication circuitry 212 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. Communication circuitry 212 may operate in accordance with other wireless protocols in other embodiments. Communication circuitry 212 may include antennas to facilitate wireless communications and/or to receive other wireless communications.

In some embodiments, communication circuitry 212 may manage wired communications, such as electrical, optical, or any other suitable communication protocols (e.g., the Ethernet, Internet). Communication circuitry 212 may include multiple communication chips. For instance, a first communication chip may be dedicated to shorter-range wireless communications such as Wi-Fi or Bluetooth, and a second communication chip may be dedicated to longer-range wireless communications such as global positioning system (GPS), EDGE, GPRS, CDMA, WiMAX, LTE, EV-DO, or others. In some embodiments, a first communication chip may be dedicated to wireless communications, and a second communication chip may be dedicated to wired communications.

The example network environment may be configured over a physical infrastructure that may include one or more networks and, further, may be configured in any form including, but not limited to, local area networks (LANs), wireless local area networks (WLANs), virtual local area networks (VLANs), metropolitan area networks (MANs), wide area networks (WANs), virtual private networks (VPNs), Intranet, Extranet, any other appropriate architecture or system, or any combination thereof that facilitates communications in a network. In some embodiments, a communication link may represent any electronic link supporting a LAN environment such as, for example, cable, Ethernet, wireless technologies (e.g., IEEE 802.11x), ATM, fiber optics, etc. or any suitable combination thereof. In other embodiments, communication links may represent a remote connection through any appropriate medium (e.g., digital subscriber lines (DSL), telephone lines, T1 lines, T3 lines, wireless, satellite, fiber optics, cable, Ethernet, etc. or any combination thereof) and/or through any additional networks such as a WANs (e.g., the Internet).

Rebilling application 100 may be implemented in tiered software framework 200 comprising at least three tiers 102: tier-1 (102-1), tier-2 (102-2), and tier-3 (102-3). Tiers 102 may be organized according to a hierarchy of management (i.e., to oversee, to control, to maintain), with upstream tiers managing downstream ones. Thus, tier 102-1 comprises operations that may manage tiers 102-2 and 102-3, whereas tier 102-2 comprises operations that may manage tier 102-3 but not tier 102-1. For purposes of terminology, tier 102-1 is “upstream” relative to tiers 102-2 and 102-3; tier 102-3 is “downstream” relative to tiers 102-2 and 102-1; tier 102-2 is downstream relative to tier 102-1 and upstream relative to tier 102-3. In some embodiments, each tier 102 may interact with the tier immediately adjacent thereto (e.g., downstream or upstream) but not with non-adjacent tiers. In some other embodiments, any tier 102 may interact with any other tier. In an example embodiment, tier 102-3 comprises marketing activities by business locations such as a dentist's office, a plumber's business, etc.; tier 102-2 comprises software operations by one or marketing agencies whose customers are the business locations of tier 102-3; and tier 101-1 comprises software operations by SaaS provider 104 whose customers are the marketing agencies of tier 102-2.

In various embodiments, tiers 102 may be partitioned into a backend 214 and a frontend 216. Backend 214 may comprise tier-1 backend 214-1, tier-2 backend 214-2, and tier-3 backend 214-3 provisioned in one or more servers 204. Likewise, frontend 216 may comprise tier-1 frontend 216-1, tier-2 frontend 216-2, and tier-3 frontend 216-3 provisioned in one or more computing devices 206. Backend 214 may comprise various modules, logic, software engines and other components that are distributed (and common) across all users of tiered software framework 200. Backend 214 may execute operations for managing and processing data, performing computations, and facilitating communication between different components, such as components of rebilling application 100. In particular embodiments, backend 214 may include operations such as data management, business logic (e.g., rebilling application 100), user authentication and authorization, security and validation, application programming interfaces (APIs) with third-party components such as payment processors, etc.

In a general sense, frontend 216 comprises at least a user interface using which users interact with tiered software framework 200. Frontend 216 may also include libraries, forms, device integrators and other components as desired and based on particular needs. Frontend 216 may be presented on a suitable display device coupled to computing device 206 and appropriate to show visual indicators, such as a heads-up display, a computer monitor, a projector, a touchscreen display, a liquid crystal display (LCD), a light-emitting diode display, and/or a flat panel display. In various embodiments, frontend 216 may be specific to the particular one of tier 102. For example, frontend 216-1 at tier-1 may comprise certain functionalities available (and visible) only to SaaS provider 104. Frontend 216-2 at tier-2 may comprise certain functionalities available (and visible) only to tier-2 subscriber 106-2. Frontend 216-3 at tier-3 may comprise certain functionalities available (and visible) only to tier-3 subscriber 106-3.

Tiered software framework 200 described and shown herein (and/or its associated structures) may also include suitable interfaces for receiving, transmitting, and/or otherwise communicating data or information in a network environment. In a general sense, the arrangements depicted in the figures may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

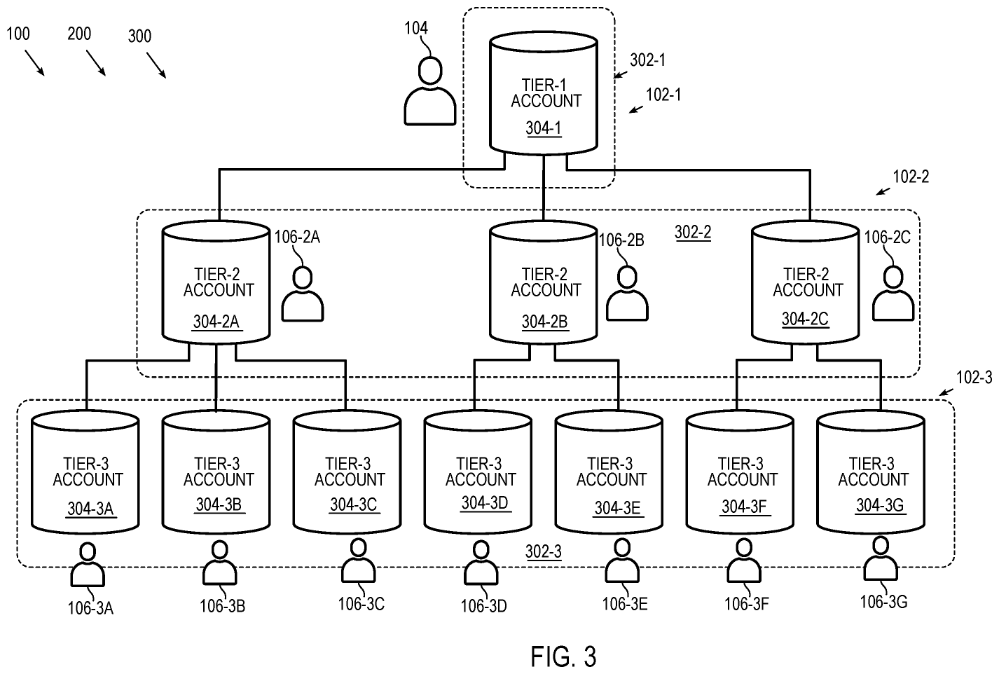

FIG. 3 is a simplified block diagram illustrating example details of data hierarchy 300 of tiered software framework 200 implementing rebilling application 100, according to some embodiments of the present disclosure. In various embodiments, data 302 communicated in tiered software framework 200 may be exclusively received from users such as SaaS provider 104 and subscribers 106-2, and 106-3; in some other embodiments, data 302 may also be received from other sources, such as third-parties and/or from the Internet. Examples of data 302 include business niche targeted by subscribers 106, marketing activities such as on social media, target audience of subscribers 106, login credentials to access various marketing platforms, frequency of marketing activities, information to be included in the content of marketing posts, customer lists, business locations, marketing platform rules, and other such data relevant to the functionalities offered by tiered software framework 200. In particular embodiments, data 302 associated with rebilling application 100 may further include information regarding price 118, discount 120, markup 122, records of metered activities 108, transactions associated with payment card 130 and digital wallet 124, and reports of transactions (among others). Data 302 may be stored in data lakes, databases, data warehouses, blockchains, file systems and other types of data storage facilities within the broad scope of the embodiments with corresponding accessing and viewing capabilities as described herein.

Data 302 in each tier 102 may be contained within accounts 304 accessible and viewable with appropriate access credentials. For example, account 304-1 may be associated with SaaS provider 104. Account 304-1 may manage a plurality of accounts 304-2 at tier 102-2. Subscriber 106-2a may have a subscription to account 304-2a in plurality of accounts 304-2. Account 304-2a may manage a plurality of accounts 304-3 at tier 102-3. Subscriber 106-3a may have a subscription to account 304-3a in plurality of accounts 304-3; subscriber 106-3b may have a subscription to account 304-3b in plurality of accounts 304-3; and subscriber 106-3c may have a subscription to account 304-3c in plurality of accounts 304-3. In other words, subscriber 106-2a has three downstream subscribers at tier 102-3, namely subscribers 106-3a, 106-3b, and 106-3c with their associated respective accounts 304-3a, 304-3b, and 304-3c. Likewise for other accounts shown in the figure. Note that such a framework is merely provided for illustrative purposes and should not be construed as a limitation. Any number of subscribers may be provided at tiers 102-2 and 102-3 in tiered software framework 200 within the broad scope of the embodiments. Note also that the labeling convention followed herein uses letters to denote a separate instance of the same component (e.g., “a” denotes instance A, “b” denotes instance B, and so on).

In various embodiments, data 302 may be arranged in data hierarchy 300 for different accounts 304 such that certain users can view and access only a subset of data 302 according to their respective tier 102 and access credentials based on particular needs (e.g., user credentials may indicate which tier 102 and which corresponding accounts 304 are available for access and view).

Such accounts 304 may be facilitated by a suitable user interface at frontend 216 for viewing the accessible data. Appropriate user authentication and authorization engines running in backend 214 may ensure that accounts 304 are maintained as desired and appropriate privacy blocks are applied at appropriate tiers 102.

In the example illustrated herein, tier-1 data 302-1 may be of account 304-1; tier-2 data 302-2 may be of accounts 304-2a, 304-2b and 304-2c corresponding to subscribers 106-2a, 106-2b and 106-2c, respectively; tier-3 data 302-3 may be of accounts 304-3a . . . 304-3g corresponding to subscribers 106-3a . . . 106-3g. Subscribers 106-3a . . . 106-3g may access and view their own respective accounts 304-3a . . . 304-3g; however, they cannot access or view other accounts 304 in the same tier 102-3 or in upstream tiers 102-2 or 102-1. Note that accessing and viewing an account refers to accessing and viewing the data of the account. Subscribers 106-2a . . . 106-2c at tier 102-3 may access and view their own respective accounts 304-2a . . . 304-2c as well as downstream accounts 304-3 of their respective subscribers 106-3; however, they cannot access or view other accounts 304-2 in the same tier 102-2, or in downstream tier 102-3 not associated with their downstream subscribers 106-3, or in upstream tier 102-1. For example, subscriber 106-2a may access and view accounts 304-2a, 304-3a, 304-3b, and 304-3c; subscriber 106-2b may access and view accounts 304-2b, 304-3d, and 304-3e; subscriber 106-2c may access and view accounts 304-2c, 304-3f, and 304-3g. SaaS provider 104 at tier 102-1 may access and view accounts 304-1 at tier 102-1, 304-2a . . . 304-2c at tier 102-2, and 304-3a . . . 304-3g at tier 102-3.

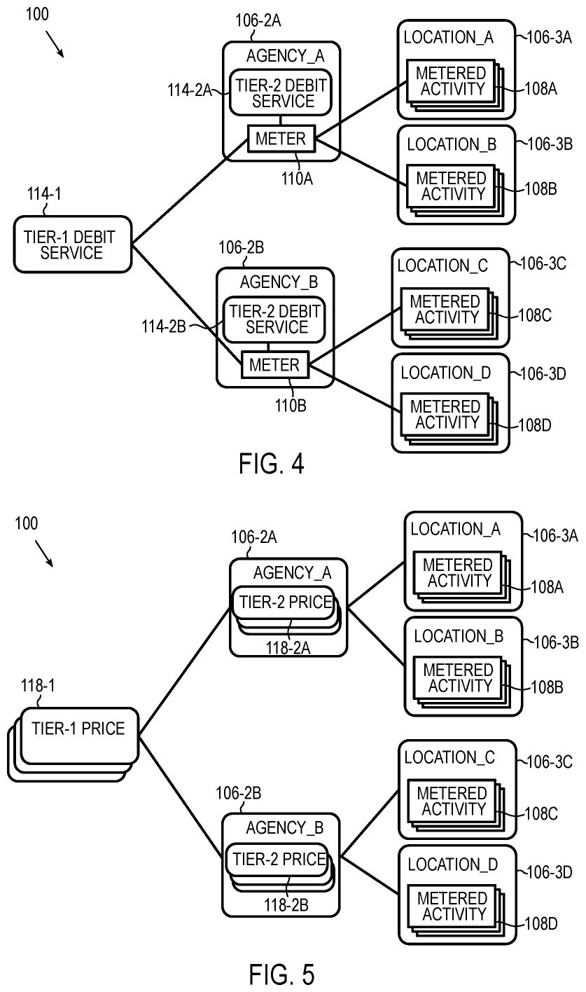

FIG. 4 is a simplified block diagram illustrating example details of rebilling application 100, according to some embodiments of the present disclosure. Debit service 114-1 at tier 102-1 may execute substantially simultaneously with one or more meters 110 that monitor metered activity 108 at tier 102-3. Assume, merely for the sake of illustration and not as a limitation, that two subscribers 106-2a and 106-2b subscribe to rebilling application 100 from SaaS provider 104 at tier 102-1. Subscriber 106-2a may be called Agency_A and subscriber 106-2 may be called Agency_B. Subscriber 106-2a has downstream subscribers 106-3a and 106-3b, which may be called respectively as Location_A and Location_B. Likewise, subscriber 106-2b has downstream subscribers 106-3c and 106-3d, called Location_C and Location_D, respectively.

Meter 110a executing at tier 102-2 and associated with subscriber 106-2a may monitor and log metered activities 108a and 108b associated with subscribers 106-3a and 106-3b, respectively. Likewise, meter 110b executing at tier 102-2 and associated with subscriber 106-2b may monitor and log metered activities 108c and 108d associated with subscribers 106-3c and 106-3d. Debit services 114-1 and 114-2a may access usage information from meter 110a. Debit services 114-1 and 114-2b may access usage information from meter 110b.

In various embodiments, the records generated by meter 110 may be tagged with information about the credentials of the user who created metered activity 108, so that it may be associated with the correct subscriber 106. In some other embodiments, each metered activity 108 may be associated with a separate instance of meter 110, so that multiple instances of meter 110 associated with a single tier-2 subscriber 106-2 may be active at any given time depending on the number of active metered activities 108. Debit services 114-1 and 114-2 may communicate with each instance of meter 110 appropriately.

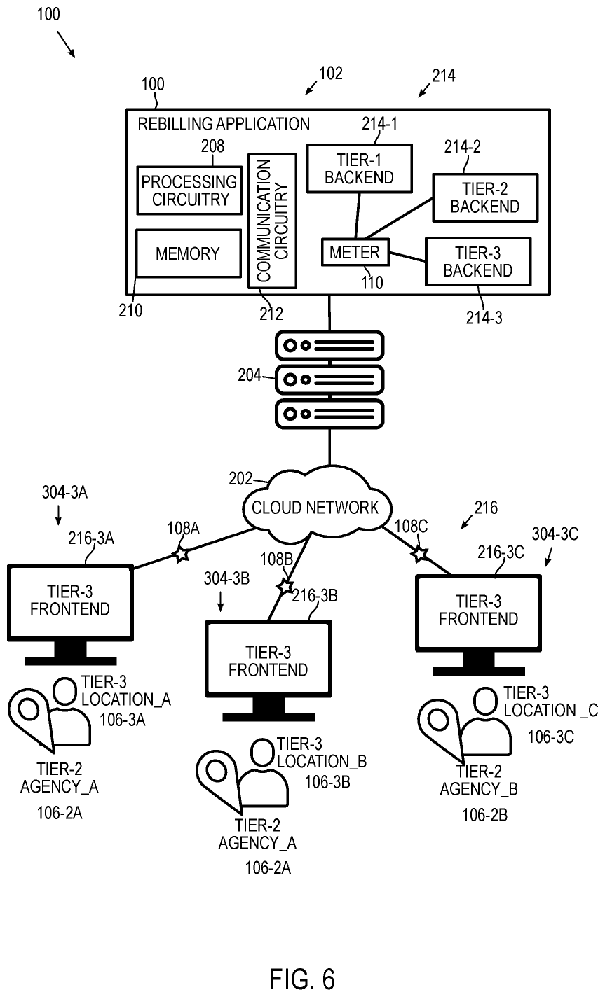

FIG. 5 is a simplified block diagram illustrating other example details of rebilling application 100 according to some embodiments of the present disclosure. Prices 118 may be set at tiers 102-1 and 102-2 separately, and in some cases, independent of each other. Assume, merely for the sake of illustration and not as a limitation, that two subscribers 106-2a and 106-2b subscribe to rebilling application 100 from SaaS provider 104 at tier 102-1. Subscriber 106-2a may be called Agency_A and subscriber 106-2 may be called Agency_B. Subscriber 106-2a has downstream subscribers 106-3a and 106-3b, which may be called respectively as Location_A and Location_B. Likewise, subscriber 106-2b has downstream subscribers 106-3c and 106-3d, called Location_C and Location_D, respectively. Subscribers 106-3a . . . 106-3d may be associated with metered activities 108a . . . 108d, respectively.

Assume also, merely for the sake of explanation, that metered activities 108a . . . 108d are all the same type, for example, sending an SMS text. All metered activities 108a . . . 108d may be subject to the same tier-1 price 118-1. However, metered activities 108a and 108b may be priced by subscriber 106-2a at tier-2 price 118-2a, whereas metered activities 108c and 108d may be priced by subscriber 106-2b at a different tier-2 price 118-2b. Thus, each subscriber 106-2 at tier 102-2 may price the same type of metered activity 108 independently within the broad scope of the embodiments herein. In some embodiments, subscriber 106-2 may also price each downstream subscriber 106-3 differently, so that tier-2 price 1182a may differ between subscribers 106-3a and 106-3b. For example, Agency_A may offer a discount to Location_A, which is a plumber, but not to Location_B, which is a medical office. Likewise, Agency_B may offer one price to Location_C, which is in urban City A and another price to Location_D, which is in rural town B.

Any criteria may be used for pricing within the broad scope of the embodiments. Further, subscribers 106-2 at tier 102-2 may set their prices 118-2 independent of each other based on their unique business needs. Thus, each metered activity 108, subject to a common tier-1 price 118-1 may be priced differently among subscribers 106-2 as well as among subscribers 106-3 based on particular needs within the broad scope of the embodiments. In yet other embodiments, tier-2 price 118-2 may be the same as tier-1 price 118-1 for all subscribers 106-3 who initiate or are otherwise associated with metered activity 108.

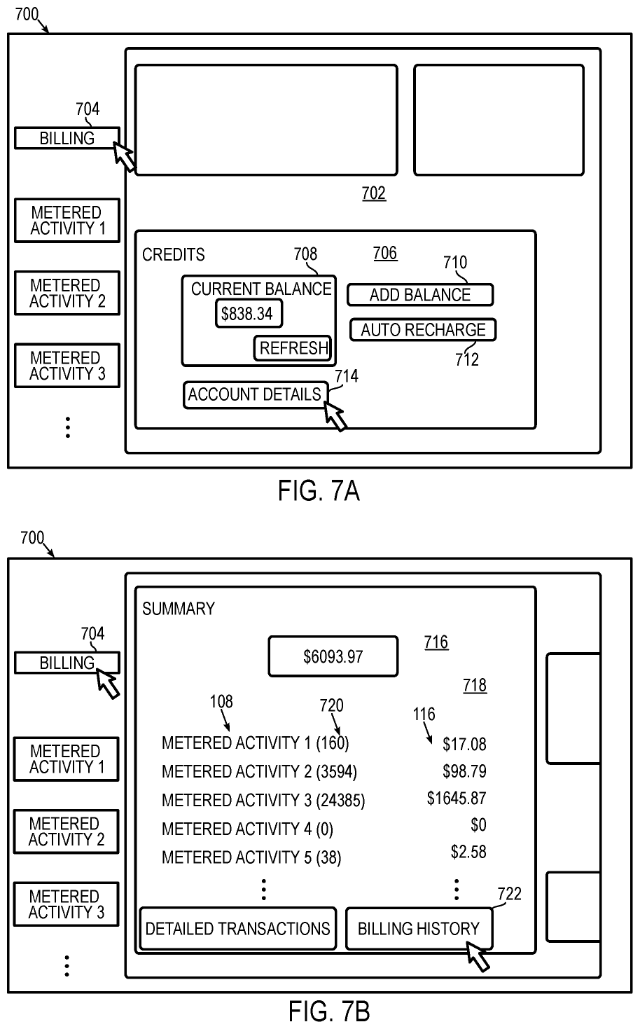

FIG. 6 is a simplified block diagram illustrating other example details of rebilling application 100, according to some embodiments of the present disclosure. Assume, merely for illustrative purposes and not as limitations, that three different users have logged into rebilling application 100 with access credentials corresponding to subscriber 106-3a, 106-3b and 106-3c. All three subscribers 106 are at tier 103-2. Assume that subscribers 106-3a and 106-3b have respective accounts 304-3a and 304-3b at tier 102-3 with subscriber 106-2a and subscriber 106-3c has account 304-3c with subscriber 106-2b. Subscribers 106-2a and 106-2b operate separate accounts at tier 102-2. Frontend 216 may display separate user interfaces 216-3a . . . 216-3c to respective subscribers 106-3a . . . 106-3c.

In various embodiments, metered activity 108a may be initiated by subscriber 106-3a. Merely as an example and not as a limitation, assume metered activity is sending of a marketing message via SMS. Meter 110 executing in backend 214 may detect metered activity 108a and begin logging usage 112a (not shown so as not to clutter the drawing). Substantially concurrently, subscriber 106-3b may initiate another metered activity 108b, which may be sending of an email message. Meter 110 may detect metered activity 108b and begin logging corresponding usage 112b. Likewise, metered activity 108c initiated by subscriber 106-3c may be logged by meter 110.

In some embodiments, a single instance of meter 110 may track substantially all metered activities 108 of subscribers 106. In some other embodiments, each subscriber 106 may be associated with a separate instance of meter 110 in backend 214. In yet other embodiments, each type of metered activity 108 may be associated with a separate instance of meter 110. For example, SMS messages may be associated with a first instance of meter 110; email messages may be associated with a second instance of meter 110; and so on. In yet other embodiments, each tier 102 may be associated with a separate instance of meter 110. For example, metered activities 108 initiated at tier 102-3 may be tracked by a first instance of meter 110; metered activities 108 initiated at tier 102-2 may be tracked by a second instance of meter 110; and so on. In various embodiments, meter 110 may execute outside any tier 102; in other embodiments, meter 110 may execute in one of tier 102-1, tier 102-2 or 102-3. In yet other embodiments, different instances of meter 110 may execute in different tiers 102 as desired and based on particular needs. Any suitable configuration of meter 110 may be provisioned in rebilling application 100 within the broad scope of the embodiments.

In various embodiments, subscriber 106-3a may be able to access and view the usage records of metered activity 108a, but not of metered activity 108b or 108c. Likewise, subscriber 106-3b may be able to access and view the usage records of metered activity 108b, but not of metered activity 108a or 108c; subscriber 106-3c may be able to access and view the usage records of metered activity 108c, but not of metered activity 108a or 108b. Subscriber 106-2a may be able to view the usage records of metered activity 108a and 108b, but not of 108c. Likewise, subscriber 106-2b may be able to view the usage records of metered activity 108c, but not of 108a or 108b. SaaS provider 104 operating at tier 102-1 may be able to view all usage records of metered activities 108a . . . 108c.

Note that the activities as described are not limited to the number of subscribers 106, or the number or type of metered activities 108. Any number of subscribers and any number and type of metered activities 108 may be included in rebilling application 100 within the broad scope of the embodiments.

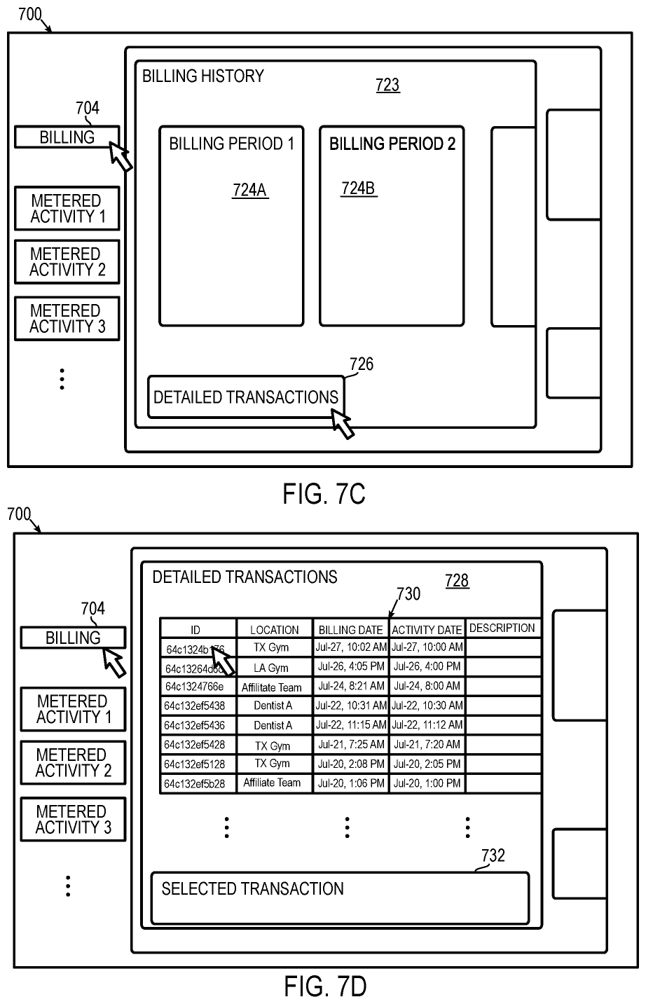

FIGS. 7A-7E are simplified diagrams illustrating example user interfaces 700 of rebilling application 100, according to some embodiments of the present disclosure. As shown in FIG. 7A, user interface 700 may display window 702 adjacent to a menu of choices, including one for billing 704. Clicking on, or otherwise selecting billing 704 may open a secondary window 706 within window 702. Secondary window 706 may show the available credits (e.g., “current balance”) in digital wallet 124 associated with the displayed account 304 in another secondary window 708. Note that subscriber 106-2 at tier 102-2 sees digital wallet 124-2 at tier 102-2, whereas subscriber 106-3 at tier 102-3 sees digital wallet 124-3 at tier 102-3. Data 302 displayed corresponds to the specific account 304 as described in reference to FIG. 3 previously. A button 710 may be provided for adding additional credit to digital wallet 124 manually. Another button 712 may be provided for automatically recharging digital wallet 124 whenever the account balance falls below a predetermined balance threshold 134 (e.g., as decided by subscriber 106). Yet another button 714 may allow drilling down into account details to see individual transactions associated with metered activity 108.

As shown in FIG. 7B, clicking on button 714 (or otherwise selecting to view account details) may open a secondary window 716 displaying a report 718 of transactions associated with usage 112 of metered activity 108. In the example shown, report 718 is a summary report. Other types of reports may be displayed based on particular needs. Any suitable type of report may be included within the broad scope of the embodiments. Report 718 may list various metered activities 108 along with a metered attribute 720 (e.g., number of the particular metered activity 108) and usage credits 116 for the corresponding metered activity 108. A button 722 may be provided for viewing a billing history.

As shown in FIG. 7C, clicking on button 722 (or otherwise selecting to view billing history) may open a secondary window 723 displaying reports 724 of past billing details. In the example shown, billing histories of different periods are displayed in separate reports 724a, 724b, etc. in their own respective windows. Any suitable format may be provided for report 724 within the broad scope of the embodiments. A button 726 may be provided for viewing a detailed list of transactions associated with metered activities 108.

As shown in FIG. 7D, clicking on button 726 (or otherwise selecting to view detailed transactions) may open a secondary window 728 displaying report 730 of transactions of each metered activity 108. In the example shown, report 730 is displayed as a table. Any suitable format for report 730 may be included within the broad scope of the embodiments. Report 730 may display each transaction associated with metered activity 108, specifying suitable metered attributes as desired and based on the specific tier 102 associated with the user credentials accessing user interface 700. For example, subscriber 106-2 at tier 102-2 may see a transaction identifier (ID) (e.g., a hexadecimal identifier) uniquely identifying a specific one of metered activity 108, along with the corresponding location, a billing date, activity date, and description (among other metered attributes). The location may indicate the specific one of subscriber 106-3 whose account 304-3 is managed by subscriber 106-2. Thus, report 730 may display all metered activities 108 associated with subscribers 106-3 whose accounts are managed at tier-2 by subscriber 106-2. Selecting a specific one of the transactions may open another secondary window 732 with further details about the selected transaction.

As shown in FIG. 7E, clicking on button 726 (or otherwise selecting to view detailed transactions) may open secondary window 728 displaying report 734 of transactions of each metered activity 108 at tier 102-3. In the example shown, report 734 is displayed as a table. Any suitable format for report 730 may be included within the broad scope of the embodiments. Report 734 may display each transaction associated with metered activity 108, specifying suitable metered attributes as desired and based on the specific tier 102-3 associated with the user credentials accessing user interface 700. For example, subscriber 106-3 at tier 102-3 may see the transaction ID uniquely identifying a specific one of metered activity 108, along with the corresponding user who initiated metered activity 108, a billing date, activity date, and description (among other metered attributes). In some embodiments, the transaction ID may be the same across all tiers 102-1 . . . 102-3 for the sake of consistency and trust (among other reasons). Thus, report 734 may display a subset of report 730, specific to the user credentials of subscriber 106-3 who is accessing their respective account 304-3.

Although the present disclosure has been described in detail with reference to particular arrangements and configurations, these example configurations and arrangements may be changed significantly without departing from the scope of the present disclosure. For example, although the present disclosure has been described with reference to particular network systems such as cloud networks, rebilling application 100 may be applicable to other networks such as local area network. Moreover, although tiered software framework 200 has been illustrated with reference to particular elements and operations that facilitate the software process, these elements, and operations may be replaced by any suitable architecture or process that achieves the intended functionality of rebilling application 100.

### Example Methods

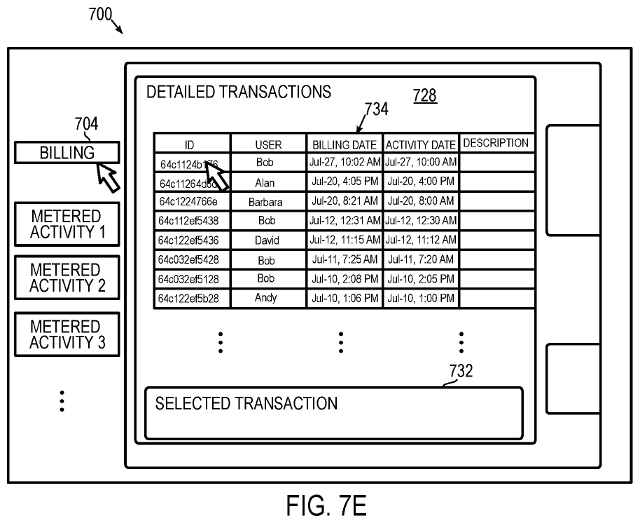

FIG. 8 is a simplified flow diagram illustrating example operations 800 associated with rebilling application 100, according to some embodiments of the present disclosure. At 802, metered activity 108 may be detected in a tier-3 account 304-3 operated by subscriber 106-3 at tier 102-3 and managed by account 304-2 operated by subscriber 106-2 at tier 102-2. In example embodiments, metering agents in rebilling application 100 may detect occurrence of metered activity 108. The metering agents may comprise appropriate software code such as event listeners, polling agents, callbacks and such other software elements integrated into rebilling application 100 suitably. In some embodiments, such metering agents may be integrated into meter 110. At 804, meter 110 may run, logging usage 112 of metered activity 108. In some embodiments, meter 110 may be instantiated when metered activity 108 is detected. In other embodiments, meter 110 may be constantly running in the background, listening for initiation of metered activity 108.

At 806, debit service 114-2 may be instantiated. Debit service 114-2 may apply price 118-2 configured at tier 102-2 by subscriber 106-2 managing account 304-3. Price 118-2 may be applied to usage 112 detected by meter 110. In some embodiments, price 118-2 may be discounted by discount 120-2 and marked up by markup 122 as appropriate. In various embodiments, price 118-2 may be applied in real-time, as metered activity 108 is occurring. At 808, debit service 114-2 may compute usage credits 116-2 for usage 112. At 810, debit service 114-2 may make a determination whether the account balance in digital wallet 124-3 at tier 102-3 is less than balance threshold 134-3. In some embodiments, balance threshold 134-3 may be set by subscriber 106-3 operating account 304-3. In some other embodiments, balance threshold 134-3 may be set by subscriber 106-2 managing account 304-3. If it is determined that the account balance in digital wallet 124-3 at tier 102-3 is less than balance threshold 134-3, at 812, digital wallet 124-3 may be topped up by activating payment processing module 132-2 and purchasing additional credits 126-2. The operations may then step to 814. If it is determined that the account balance in digital wallet 124-3 at tier 102-3 is not less than the balance threshold 134-3, at 814, debit service 114-2 may debit usage credits 116-2 from digital wallet 124-3.

Substantially simultaneously as 806, the operations may fork to 816, at which debit service 114-1 may be instantiated. Debit service 114-1 may apply price 118-1 configured at tier 102-1 by SaaS provider 104 managing account 304-2. Price 118-1 may be applied to usage 112 detected by meter 110. In some embodiments, price 118-1 may be discounted by discount 120-1 as appropriate. In various embodiments, price 118-1 may be applied in real-time, as metered activity 108 is occurring. At 818, debit service 114-1 may compute usage credits 116-1 for usage 112. At 820, debit service 114-1 may make a determination whether the account balance in digital wallet 124-2 at tier 102-2 is less than another balance threshold 134-2. In some embodiments, the another balance threshold 134-2 may be set by subscriber 106-2 operating account 304-2 that manages account 304-3 at which metered activity 108 is occurring. In some other embodiments, the another balance threshold 134-2 may be set by SaaS provider 104 managing account 304-2. If it is determined that the account balance in digital wallet 124-2 at tier 102-2 is less than the another balance threshold 134-2, at 822, digital wallet 124-2 may be topped up by activating payment processing module 132-1 and purchasing additional credits 126-1. The operations may then step to 824. If it is determined that the account balance in digital wallet 124-2 at tier 102-2 is not less than the another balance threshold 134-2, at 824, debit service 114-1 may debit usage credits 116-1 from digital wallet 124-2.

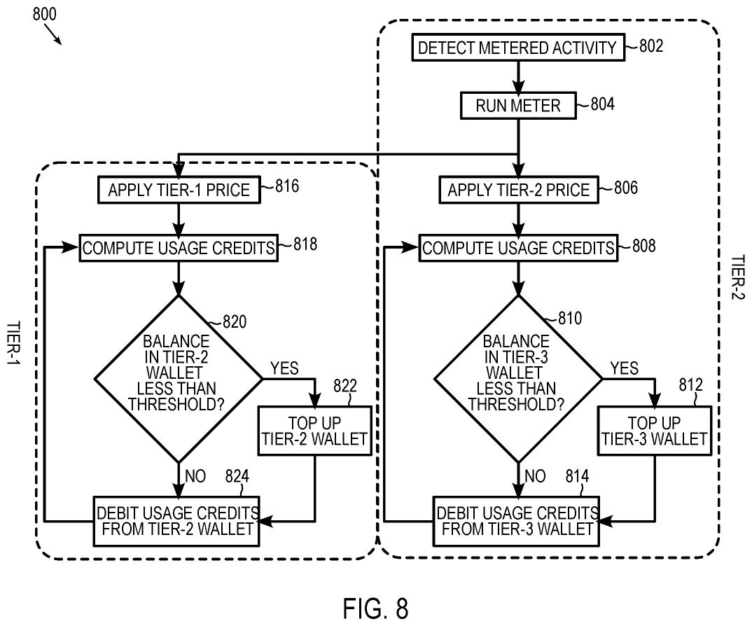

FIG. 9 is a simplified flow diagram illustrating yet other example operations 900 associated with rebilling application 100, according to some embodiments of the present disclosure. At 902, payment processing module 132 may initiate payment processing. At 904, payment processing module 132 may pull information of payment card 130 at the immediately downstream tier 102. At 906, payment processing module 132 may determine a maximum credit allowed for digital wallet 124 at the immediately downstream tier 102. At 908, payment processing module 132 may submit a payment request to a third-party payment processor such as Stripe™ using an appropriate API for the maximum allowed credit for digital wallet 124.

Note that the operations as described may occur at any one or more of tiers 102-2 or 102-3 appropriately. For example, payment processing module 132-2 may initiate payment processing at tier 102-2. Payment processing module 132-2 may pull information about payment card 130-3 at tier 102-3. Payment processing module 132-2 may determine a maximum credit allowed for digital wallet 124-3 and submit the request for the maximum credit allowed for digital wallet 124-3. In another example, payment processing module 132-1 may initiate payment processing at tier 102-1. Payment processing module 132-1 may pull information about payment card 130-2 at tier 102-2. Payment processing module 132-1 may determine a maximum credit allowed for digital wallet 124-2 and submit the request for the maximum credit allowed for digital wallet 124-2.

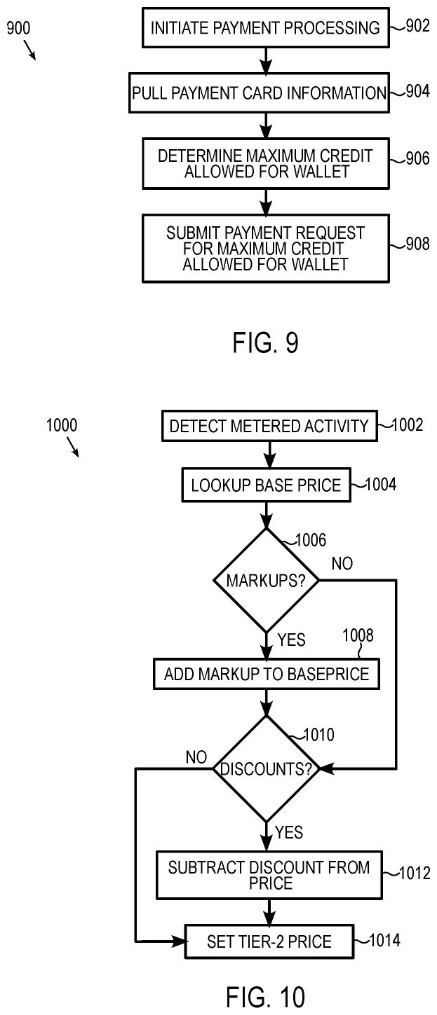

FIG. 10 is a simplified flow diagram illustrating yet other example operations 1000 associated with rebilling application 100, according to some embodiments of the present disclosure. In various embodiments, operations 1000 may execute at tier 102-2. At 1002, meter 110 may detect metered activity 108. Debit service 114-2 may lookup a base price at 1004. In some embodiments, the base price may be same as tier-1 price 118-1 that is charged by SaaS provider 104 to subscriber 106-2 at tier-2. In some other embodiments, the base price may be price 118-1 reduced by discount 120-1 as charged by SaaS provider 104 to subscriber 106-2 at tier-2. In yet other embodiments, the base price may be configured by subscriber 106-2 independent of tier-1 price 118-1. At 1006, a determination may be made whether any markups 122 are configured for metered activity 108. If so, markup 122 may be added to the base price. The operations may then step to 1010. At 1006, if it is determined that no markups are configured, the operations may step to 1010. At 1010, a determination may be made whether discounts 120-2 are to be applied. If not, the operations step to 1014. If discount 120-2 is to be applied, at 1012, discount 1202-2 may be applied to the price (either base price if no markup 122 was applied, or the marked up price if markup 122 was applied) and price reduced appropriately. At 1014, tier-2 price 118-2 may be set as one of the values determined at 1004, 1008 or 1012 depending on whether markup 122 or discount 120-2 was applied.

In some embodiments, operations 1000 may be performed automatically by debit service 114-2 for each type (e.g., category) of metered activity 108 at tier 102-2 and for each downstream account 304-3 or subscriber 106-3 as desired and based on particular needs. In some embodiments, operations 1000 may be performed automatically each time metered activity 108 is detected, so that the most current price 118-2 is applied to usage 112. Thus, any discounts 120-2 or markup 122 may be applied in real-time to usage 112, allowing for greater efficiency in metering and billing.

Although FIGS. 8-10 illustrate various operations performed in a particular order, this is simply illustrative, and the operations discussed herein may be reordered and/or repeated as suitable. Further, additional operations which are not illustrated may also be performed without departing from the scope of the present disclosure. Also, various ones of the operations discussed herein with respect to FIGS. 8-10 may be modified in accordance with the present disclosure to automatically meter and bill for metered activity 108 as disclosed herein. Although various operations are illustrated in FIGS. 8-10 once each, the operations may be repeated as often as desired.

It is important to note that the operations described with reference to the preceding figures illustrate only some of the possible scenarios that may be executed by, or within, rebilling application 100. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion.

### Select Examples

Example 1 provides a method for automatically rebilling a metered activity in a tiered software framework, the method including detecting a metered activity in a tiered software framework, in which: the tiered software framework includes a first tier, a second tier, and a third tier. A first subscriber is subscribed to the second tier, a second subscriber is subscribed to the third tier, and the metering activity is by the second subscriber. The method further includes instantiating a meter to monitor usage of the metered activity; simultaneously instantiating a first debit service at the first tier and a second debit service at the second tier; computing, by the first debit service, first usage credits of the usage; debiting the first usage credits from a first digital wallet of the first subscriber at the second tier; computing, by the second debit service, second usage credits of the usage; and debiting the second usage credits from a second digital wallet of the second subscriber at the third tier.

Example 2 provides the method of example 1, in which: the first usage credits are computed as a product of a billing rate times the usage, and the billing rate is a function of a price assigned to the metered activity at the first tier.

Example 3 provides the method of example 2, in which the billing rate is the price reduced by a discount at the first tier.

Example 4 provides the method of any one of examples 1-3, in which: the second usage credits are computed as a product of a billing rate times the usage, and the billing rate is a function of a price assigned to the metered activity at the second tier.

Example 5 provides the method of example 4, in which the billing rate is the price reduced by a discount at the second tier and increased by a markup at the second tier.

Example 6 provides the method of example 5, further including looking up the price at the second tier for the metered activity; determining that a discount exists at the second tier for the metered activity; and reducing the price by the discount.

Example 7 provides the method of example 6, further including looking up the price at the second tier for the metered activity; determining that a markup exists at the second tier for the metered activity; and increasing the price by the markup.

Example 8 provides the method of any one of examples 1-7, further including determining that available credits in the first digital wallet are below a predetermined threshold; retrieving, by a payment process executing in the first tier, information on a payment card in the second tier; purchasing, by the payment process, a predetermined number of credits using the information on the payment card; and adding, by a credit addition service at the first tier, the predetermined number of credits to the first digital wallet.

Example 9 provides the method of example 8, further including determining that available credits in the second digital wallet are below another predetermined threshold; retrieving, by another payment process executing in the second tier, information on another payment card in the third tier; purchasing, by the another payment process, another predetermined number of credits using the information on the another payment card; and adding the predetermined number of credits to the second digital wallet.

Example 10 provides the method of any one of examples 1-9, in which: data of the second subscriber is visible and accessible to the first subscriber, and data of the first subscriber is not visible and accessible to the second subscriber.

Example 11 provides non-transitory computer-readable tangible media that includes instructions for execution, which when executed by a processor of a computing device, is operable to perform operations including detecting a metered activity in a tiered software framework that includes a first tier, a second tier, and a third tier. A first subscriber is subscribed to the second tier, a second subscriber is subscribed to the third tier, and the metering activity is by the second subscriber. The operations further include instantiating a meter to monitor usage of the metered activity; simultaneously instantiating a first debit service at the first tier and a second debit service at the second tier; computing, by the first debit service, first usage credits of the usage; debiting the first usage credits from a first digital wallet of the first subscriber at the second tier; computing, by the second debit service, second usage credits of the usage; and debiting the second usage credits from a second digital wallet of the second subscriber at the third tier.

Example 12 provides the non-transitory computer-readable tangible media of example 11, in which: the first usage credits are computed as a product of a billing rate times the usage, and the billing rate is a function of a price assigned to the metered activity at the first tier.

Example 13 provides the non-transitory computer-readable tangible media of 12, in which the billing rate is the price reduced by a discount at the first tier.

Example 14 provides the non-transitory computer-readable tangible media of any one of examples 11-13, in which: the second usage credits are computed as a product of a billing rate times the usage, and the billing rate is a function of a price assigned to the metered activity at the second tier. 15.

Example 15 provides the non-transitory computer-readable tangible media of claim 14, in which the billing rate is the price reduced by a discount at the second tier and increased by a markup at the second tier.

Example 16 provides the non-transitory computer-readable tangible media of example 15, in which the operations further include looking up the price at the second tier for the metered activity; determining that a discount exists at the second tier for the metered activity; and reducing the price by the discount.

Example 17 provides the non-transitory computer-readable tangible media of claim 16, in which the operations further include looking up the price at the second tier for the metered activity; determining that a markup exists at the second tier for the metered activity; and increasing the price by the markup.

Example 18 provides the non-transitory computer-readable tangible media of any one of claims 11-17, in which the operations further include determining that available credits in the first digital wallet are below a predetermined threshold; retrieving, by a payment process executing in the first tier, information on a payment card in the second tier; purchasing, by the payment process, a predetermined number of credits using the information on the payment card; and adding, by a credit addition service at the first tier, the predetermined number of credits to the first digital wallet.

Example 19 provides the non-transitory computer-readable tangible media of claim 18, in which the operations further include determining that available credits in the second digital wallet are below another predetermined threshold; retrieving, by another payment process executing in the second tier, information on another payment card in the third tier; purchasing, by the another payment process, another predetermined number of credits using the information on the another payment card; and adding the predetermined number of credits to the second digital wallet.

Example 20 provides the non-transitory computer-readable tangible media of any one of claims 11-19, in which: data of the second subscriber is visible and accessible to the first subscriber, and data of the first subscriber is not visible and accessible to the second subscriber.

Example 21 provides an apparatus including a processing circuitry; a memory storing data; and a communication circuitry, in which the processing circuitry executes instructions associated with the data, the processing circuitry is coupled to the communication circuitry and the memory, and the processing circuitry and the memory cooperate, such that the apparatus is configured for: detecting a metered activity in a tiered software framework that includes a first tier, a second tier, and a third tier. A first subscriber is subscribed to the second tier, a second subscriber is subscribed to the third tier, and the metering activity is by the second subscriber. The apparatus is further configured for instantiating a meter to monitor usage of the metered activity; simultaneously instantiating a first debit service at the first tier and a second debit service at the second tier; computing, by the first debit service, first usage credits of the usage; debiting the first usage credits from a first digital wallet of the first subscriber at the second tier; computing, by the second debit service, second usage credits of the usage; and debiting the second usage credits from a second digital wallet of the second subscriber at the third tier.

Example 22 provides the apparatus of example 21, in which: the first usage credits are computed as a product of a billing rate times the usage, and the billing rate is a function of a price assigned to the metered activity at the first tier.

Example 23 provides the apparatus of 22, in which the billing rate is the price reduced by a discount at the first tier.

Example 24 provides the apparatus of any one of examples 21-23, in which: the second usage credits are computed as a product of a billing rate times the usage, and the billing rate is a function of a price assigned to the metered activity at the second tier.

Example 25 provides the apparatus of claim 24, in which the billing rate is the price reduced by a discount at the second tier and increased by a markup at the second tier.

Example 26 provides the apparatus of example 25, further configured for: looking up the price at the second tier for the metered activity; determining that a discount exists at the second tier for the metered activity; and reducing the price by the discount.

Example 27 provides the apparatus of claim 26, further configured for: looking up the price at the second tier for the metered activity; determining that a markup exists at the second tier for the metered activity; and increasing the price by the markup.

Example 28 provides the apparatus of any one of claims 21-27, further configured for: determining that available credits in the first digital wallet are below a predetermined threshold; retrieving, by a payment process executing in the first tier, information on a payment card in the second tier; purchasing, by the payment process, a predetermined number of credits using the information on the payment card; and adding, by a credit addition service at the first tier, the predetermined number of credits to the first digital wallet.

Example 29 provides the apparatus of claim 28, further configured for: determining that available credits in the second digital wallet are below another predetermined threshold; retrieving, by another payment process executing in the second tier, information on another payment card in the third tier; purchasing, by the another payment process, another predetermined number of credits using the information on the another payment card; and adding the predetermined number of credits to the second digital wallet.

Example 30 provides the apparatus of any one of claims 21-29, in which: data of the second subscriber is visible and accessible to the first subscriber, and data of the first subscriber is not visible and accessible to the second subscriber.

Example 31 provides a method for automatically rebilling a metered activity in a tiered software framework, the method including providing a first tier, a second tier and a third tier in a software framework, in which: data in the first tier is accessible at the first tier and inaccessible at the second tier and the third tier, data in the second tier is accessible at the first tier and the second tier and inaccessible at the third tier, and data in the third tier is accessible at the first tier, the second tier and the third tier. The method further includes providing a first digital wallet in the second tier and a second digital wallet in the third tier; providing a first payment process in the first tier and a second payment process in the second tier; determining, at the first tier, that available credits in the first digital wallet are below a predetermined threshold; purchasing, by the first payment process, a first number of credits using information on a first payment card provided at the second tier; determining, at the second tier, that available credits in the second digital wallet are below another predetermined threshold; purchasing, by the second payment process, a second number of credits using information on a second payment card provided at the third tier; adding, by a first credit addition service at the first tier, the first number of credits to the first digital wallet; and adding, by a second credit addition service at the second tier, the second number of credits to the second digital wallet.

Example 32 provides the method of example 31, further including providing a meter to monitor for a metered activity, the metered activity being in the third tier; detecting the metered activity; instantiating the meter to monitor usage of the metered activity; simultaneously instantiating a first debit service at the first tier and a second debit service at the second tier; computing, by the first debit service, first usage credits of the usage; debiting the first usage credits from the first digital wallet; computing, by the second debit service, second usage credits of the usage; and debiting the second usage credits from the second digital wallet.

Example 33 provides the method of example 32, in which: the first usage credits are computed as a function of the usage, and a first price assigned to the metered activity at the first tier reduced by a first discount applied at the first tier, and the second usage credits are computed as a function of the usage, and a second price assigned to the metered activity at the second tier reduced by a second discount applied at the second tier and increased by a markup applied at the second tier.

Example 34 provides the method of any one of examples 32-33, in which: the available credits in the first digital wallet are the first number of credits reduced by the first usage credits, and the available credits in the second digital wallet are the second number of credits reduced by the second usage credits.

Example 35 provides the method of any one of examples 32-34, further including generating a first report of transactions of the usage at the first tier; generating a second report of transactions of the usage at the second tier; and generating a third report of transactions of the usage at the third tier.

Example 36 provides the method of example 35, further including displaying the first report in a first user interface at the first tier; displaying the second report in a second user interface at the second tier; and displaying the third report in a third user interface at the third tier.

Example 37 provides the method of any one of claims 35-36, in which: the first report includes an identifier of a first subscriber at the second tier, the second report includes an identifier of a second subscriber at the third tier, and the third report includes an identifier of a user who initiated the metered activity.

Example 38 provides the method of example 37, in which: the first subscriber has a first subscription to a first account at the second tier, the first account manages a plurality of second accounts at the third tier, the second subscriber has a second subscription to one of the second accounts in the plurality of second accounts.

Example 39 provides the method of any one of examples 32-38, in which the meter is provided in the second tier.

Example 40 provides the method of any one of examples 31-39, in which: the data in the second tier includes a first maximum limit to credits in the first digital wallet, the data in the third tier includes a second maximum limit to credits in the second digital wallet, the first number of credits is less than or equal to the first maximum limit, and the second number of credits is less than or equal to the second maximum limit.

Example 41 provides non-transitory computer-readable tangible media that includes instructions for execution, which when executed by a processor of a computing device, is operable to perform operations including providing a first tier, a second tier and a third tier in a software framework, in which: data in the first tier is accessible at the first tier and inaccessible at the second tier and the third tier, data in the second tier is accessible at the first tier and the second tier and inaccessible at the third tier, and data in the third tier is accessible at the first tier, the second tier and the third tier. The operations further include providing a first digital wallet in the second tier and a second digital wallet in the third tier; providing a first payment process in the first tier and a second payment process in the second tier; determining, at the first tier, that available credits in the first digital wallet are below a predetermined threshold; purchasing, by the first payment process, a first number of credits using information on a first payment card provided at the second tier; determining, at the second tier, that available credits in the second digital wallet are below another predetermined threshold; purchasing, by the second payment process, a second number of credits using information on a second payment card provided at the third tier; adding, by a first credit addition service at the first tier, the first number of credits to the first digital wallet; and adding, by a second credit addition service at the second tier, the second number of credits to the second digital wallet.

Example 42 provides the non-transitory computer-readable tangible media of example 41, in which the operations further include providing a meter to monitor for a metered activity, the metered activity being in the third tier; detecting the metered activity; instantiating the meter to monitor usage of the metered activity; simultaneously instantiating a first debit service at the first tier and a second debit service at the second tier; computing, by the first debit service, first usage credits of the usage; debiting the first usage credits from the first digital wallet; computing, by the second debit service, second usage credits of the usage; and debiting the second usage credits from the second digital wallet.

Example 43 provides the non-transitory computer-readable tangible media of example 42, in which: the first usage credits are computed as a function of the usage, and a first price assigned to the metered activity at the first tier reduced by a first discount applied at the first tier, and the second usage credits are computed as a function of the usage, and a second price assigned to the metered activity at the second tier reduced by a second discount applied at the second tier and increased by a markup applied at the second tier.

Example 44 provides the non-transitory computer-readable tangible media of any one of examples 42-43, in which: the available credits in the first digital wallet are the first number of credits reduced by the first usage credits, and the available credits in the second digital wallet are the second number of credits reduced by the second usage credits.

Example 45 provides the non-transitory computer-readable tangible media of any one of examples 42-44, in which the operations further include generating a first report of transactions of the usage at the first tier; generating a second report of transactions of the usage at the second tier; and generating a third report of transactions of the usage at the third tier.

Example 46 provides the non-transitory computer-readable tangible media of example 45, in which the operations further include displaying the first report in a first user interface at the first tier; displaying the second report in a second user interface at the second tier; and displaying the third report in a third user interface at the third tier.

Example 47 provides the non-transitory computer-readable tangible media of any one of examples 45-46, in which: the first report includes an identifier of a first subscriber at the second tier, the second report includes an identifier of a second subscriber at the third tier, and the third report includes an identifier of a user who initiated the metered activity.

Example 48 provides the non-transitory computer-readable tangible media of example 47, in which: the first subscriber has a first subscription to a first account at the second tier, the first account manages a plurality of second accounts at the third tier, the second subscriber has a second subscription to one of the second accounts in the plurality of second accounts.

Example 49 provides the non-transitory computer-readable tangible media of any one of examples 42-48, in which the meter is provided in the second tier.

Example 50 provides the non-transitory computer-readable tangible media of any one of examples 41-49, in which: the data in the second tier includes a first maximum limit to credits in the first digital wallet, the data in the third tier includes a second maximum limit to credits in the second digital wallet, the first number of credits is less than or equal to the first maximum limit, and the second number of credits is less than or equal to the second maximum limit.

Example 51 provides an apparatus including a processing circuitry; a memory storing data; and a communication circuitry, in which the processing circuitry executes instructions associated with the data, the processing circuitry is coupled to the communication circuitry and the memory, and the processing circuitry and the memory cooperate, such that the apparatus is configured for: providing a first tier, a second tier and a third tier in a software framework, in which: data in the first tier is accessible at the first tier and inaccessible at the second tier and the third tier, data in the second tier is accessible at the first tier and the second tier and inaccessible at the third tier, and data in the third tier is accessible at the first tier, the second tier and the third tier. The apparatus is further configured for providing a first digital wallet in the second tier and a second digital wallet in the third tier; providing a first payment process in the first tier and a second payment process in the second tier; determining, at the first tier, that available credits in the first digital wallet are below a predetermined threshold; purchasing, by the first payment process, a first number of credits using information on a first payment card provided at the second tier; determining, at the second tier, that available credits in the second digital wallet are below another predetermined threshold; purchasing, by the second payment process, a second number of credits using information on a second payment card provided at the third tier; adding, by a first credit addition service at the first tier, the first number of credits to the first digital wallet; and adding, by a second credit addition service at the second tier, the second number of credits to the second digital wallet.

Example 52 provides the apparatus of example 51, further configured for: providing a meter to monitor for a metered activity, the metered activity being in the third tier; detecting the metered activity; instantiating the meter to monitor usage of the metered activity; simultaneously instantiating a first debit service at the first tier and a second debit service at the second tier; computing, by the first debit service, first usage credits of the usage; debiting the first usage credits from the first digital wallet; computing, by the second debit service, second usage credits of the usage; and debiting the second usage credits from the second digital wallet.

Example 53 provides the apparatus of example 52, in which: the first usage credits are computed as a function of the usage, and a first price assigned to the metered activity at the first tier reduced by a first discount applied at the first tier, and the second usage credits are computed as a function of the usage, and a second price assigned to the metered activity at the second tier reduced by a second discount applied at the second tier and increased by a markup applied at the second tier.

Example 54 provides the apparatus of any one of examples 52-53, in which: the available credits in the first digital wallet are the first number of credits reduced by the first usage credits, and the available credits in the second digital wallet are the second number of credits reduced by the second usage credits.

Example 55 provides the apparatus of any one of examples 52-54, further configured for: generating a first report of transactions of the usage at the first tier; generating a second report of transactions of the usage at the second tier; and generating a third report of transactions of the usage at the third tier.

Example 56 provides the apparatus of example 55, further configured for: displaying the first report in a first user interface at the first tier; displaying the second report in a second user interface at the second tier; and displaying the third report in a third user interface at the third tier.

Example 57 provides the apparatus of any one of examples 55-56, in which: the first report includes an identifier of a first subscriber at the second tier, the second report includes an identifier of a second subscriber at the third tier, and the third report includes an identifier of a user who initiated the metered activity.

Example 58 provides the apparatus of example 57, in which: the first subscriber has a first subscription to a first account at the second tier, the first account manages a plurality of second accounts at the third tier, and the second subscriber has a second subscription to one of the second accounts in the plurality of second accounts.

Example 59 provides the apparatus of any one of examples 52-58, in which the meter is provided in the second tier.

Example 60 provides the apparatus of any one of examples 51-59, in which: the data in the second tier includes a first maximum limit to credits in the first digital wallet, the data in the third tier includes a second maximum limit to credits in the second digital wallet, the first number of credits is less than or equal to the first maximum limit, and the second number of credits is less than or equal to the second maximum limit.

The above description of illustrated implementations of the disclosure, including what is described in the abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

1. A method for automatically rebilling a metered activity in a tiered software framework, the method comprising:
detecting a metered activity in a tiered software framework, wherein:
the tiered software framework comprises a first tier, a second tier, and a third tier,
a first subscriber is subscribed to the second tier,
a second subscriber is subscribed to the third tier, and
the metering activity is by the second subscriber;
instantiating a meter to monitor usage of the metered activity;
simultaneously instantiating a first debit service at the first tier and a second debit service at the second tier;
computing, by the first debit service, first usage credits of the usage;
debiting the first usage credits from a first digital wallet of the first subscriber at the second tier;
computing, by the second debit service, second usage credits of the usage; and
debiting the second usage credits from a second digital wallet of the second subscriber at the third tier.

2. The method of claim 1, wherein:
the first usage credits are computed as a product of a billing rate times the usage, and
the billing rate is a function of a price assigned to the metered activity at the first tier.

3. The method of claim 1, wherein:
the second usage credits are computed as a product of a billing rate times the usage, and
the billing rate is a function of a price assigned to the metered activity at the second tier.

4. The method of claim 3, wherein the billing rate is the price reduced by a discount at the second tier and increased by a markup at the second tier.

5. The method of claim 1, further comprising:
determining that available credits in the first digital wallet are below a predetermined threshold;
retrieving, by a payment process executing in the first tier, information on a payment card in the second tier;
purchasing, by the payment process, a predetermined number of credits using the information on the payment card; and
adding, by a credit addition service at the first tier, the predetermined number of credits to the first digital wallet.

6. The method of claim 5, further comprising:
determining that available credits in the second digital wallet are below another predetermined threshold;
retrieving, by another payment process executing in the second tier, information on another payment card in the third tier;
purchasing, by the another payment process, another predetermined number of credits using the information on the another payment card; and
adding the predetermined number of credits to the second digital wallet.

7. The method of claim 1, wherein:
data of the second subscriber is visible and accessible to the first subscriber, and
data of the first subscriber is not visible and accessible to the second subscriber.

8. Non-transitory computer-readable tangible media that includes instructions for execution, which when executed by a processor of a computing device, is operable to perform operations comprising:
detecting a metered activity in a tiered software framework, wherein:
the tiered software framework comprises a first tier, a second tier, and a third tier,
a first subscriber is subscribed to the second tier,
a second subscriber is subscribed to the third tier, and
the metering activity is by the second subscriber;
instantiating a meter to monitor usage of the metered activity;
simultaneously instantiating a first debit service at the first tier and a second debit service at the second tier;
computing, by the first debit service, first usage credits of the usage;
debiting the first usage credits from a first digital wallet of the first subscriber at the second tier;
computing, by the second debit service, second usage credits of the usage; and
debiting the second usage credits from a second digital wallet of the second subscriber at the third tier.

9. The non-transitory computer-readable tangible media of claim 8, wherein:
the first usage credits are computed as a product of a billing rate times the usage, and
the billing rate is a function of a price assigned to the metered activity at the first tier.

10. The non-transitory computer-readable tangible media of claim 8, wherein:
the second usage credits are computed as a product of a billing rate times the usage, and
the billing rate is a function of a price assigned to the metered activity at the second tier.

11. The non-transitory computer-readable tangible media of claim 10, wherein the billing rate is the price reduced by a discount at the second tier and increased by a markup at the second tier.

12. The non-transitory computer-readable tangible media of claim 8, wherein the operations further comprise:
determining that available credits in the first digital wallet are below a predetermined threshold;
retrieving, by a payment process executing in the first tier, information on a payment card in the second tier;
purchasing, by the payment process, a predetermined number of credits using the information on the payment card; and
adding, by a credit addition service at the first tier, the predetermined number of credits to the first digital wallet.

13. The non-transitory computer-readable tangible media of claim 12, wherein the operations further comprise:
determining that available credits in the second digital wallet are below another predetermined threshold;
retrieving, by another payment process executing in the second tier, information on another payment card in the third tier;
purchasing, by the another payment process, another predetermined number of credits using the information on the another payment card; and
adding the predetermined number of credits to the second digital wallet.

14. The non-transitory computer-readable tangible media of claim 8, wherein:
data of the second subscriber is visible and accessible to the first subscriber, and
data of the first subscriber is not visible and accessible to the second subscriber.

15. An apparatus comprising:
a processing circuitry;
a memory storing data; and
a communication circuitry, wherein the processing circuitry executes instructions associated with the data, the processing circuitry is coupled to the communication circuitry and the memory, and the processing circuitry and the memory cooperate, such that the apparatus is configured for:
detecting a metered activity in a tiered software framework, wherein:
the tiered software framework comprises a first tier, a second tier, and a third tier,
a first subscriber is subscribed to the second tier,
a second subscriber is subscribed to the third tier, and
the metering activity is by the second subscriber;
instantiating a meter to monitor usage of the metered activity;
simultaneously instantiating a first debit service at the first tier and a second debit service at the second tier;
computing, by the first debit service, first usage credits of the usage;
debiting the first usage credits from a first digital wallet of the first subscriber at the second tier;
computing, by the second debit service, second usage credits of the usage; and
debiting the second usage credits from a second digital wallet of the second subscriber at the third tier.

16. The apparatus of claim 15, wherein:
the first usage credits are computed as a product of a billing rate times the usage, and
the billing rate is a function of a price assigned to the metered activity at the first tier.

17. The apparatus of claim 15, wherein:
the second usage credits are computed as a product of a billing rate times the usage, and
the billing rate is a function of a price assigned to the metered activity at the second tier.

18. The apparatus of claim 15, further configured for:
determining that available credits in the first digital wallet are below a predetermined threshold;
retrieving, by a payment process executing in the first tier, information on a payment card in the second tier;
purchasing, by the payment process, a predetermined number of credits using the information on the payment card; and
adding, by a credit addition service at the first tier, the predetermined number of credits to the first digital wallet.

19. The apparatus of claim 18, further configured for:
determining that available credits in the second digital wallet are below another predetermined threshold;
retrieving, by another payment process executing in the second tier, information on another payment card in the third tier;
purchasing, by the another payment process, another predetermined number of credits using the information on the another payment card; and
adding the predetermined number of credits to the second digital wallet.

20. The apparatus of claim 15, wherein:
data of the second subscriber is visible and accessible to the first subscriber, and
data of the first subscriber is not visible and accessible to the second subscriber.
